(19) United States
(12) Patent Application Publication
(10) Pub. No.: US 2002/0034567 A1
(43) Pub. Date: Mar. 21, 2002

(54) System for popping popcorn

(76) Inventors: Stephen C. Jacobsen, Salt Lake City, UT (US); Fraser Smith, Salt Lake City, UT (US)

Correspondence Address: Clifton W. Thompson, THORPE, NORTH & WESTERN L.L.P., P.O. Box 1219, Sandy, UT, 84091-1219, US

(21) Appl. No.: 09/938,899

(22) Filed: Aug. 23, 2001

Related U.S. Application Data
(63) Continuation-in-part of application No. 09/438,092, filed on Nov. 10, 1999, now abandoned.

(51) Int. Cl. A23P 1/14

(52) U.S. Cl. 426/241

(57) ABSTRACT

A system for popping popcorn including selecting an electromagnetic wave frequency that is substantially optimally matched to heat a water-containing portion of the kernel, and which avoids substantially heating a pericarp of the kernel; and exposing the kernel to projected radiant energy at said electromagnetic wave frequency at a sufficient intensity for a period of time sufficient to enable the kernel to pop. A conveyer system can be used to carry substantially a single layer of kernels through the projected radiation.

The present application is a continuation-in-part of co-pending U.S. patent application Ser. No. 09/438,092 filed on Nov. 10, 1999.

### FIELD OF THE INVENTION

The present invention relates to a method and apparatus for popping popcorn. More specifically, the invention relates to a system for obtaining an improved popcorn product.

### BACKGROUND OF THE INVENTION

Popcorn, a cereal grain, is about three-fourths carbohydrate in the form of starch, with smaller amounts of protein, fat, minerals, and water. Individual popcorn kernels consist of three major parts, including the pericarp (the hull or outer covering), the germ (the portion that sprouts), and the endosperm (the starch that expands). As is known in the art, water plays a significant role in the popping process. Typically, when heated, the moisture inside the kernel turns into steam. The hotter this steam becomes, the more the pressure rises within the pericarp, resulting in a strong outward force. Eventually, the pericarp rips open under the stress and exposes the steam-laden starch to the surrounding low-pressure air. The pressure differential due to the steam within the material pushes the starch outward, expanding it to many times its original size.

With respect to the starch component, there are generally two types of endosperm: translucent and opaque. The expansion, or popping, takes place primarily in the tightly packed translucent endosperm portion of the kernel. As popcorn contains mostly the translucent endosperm type, it is much better for popping than other corn kernels. Additionally, a moisture content of about 13-14% by mass in popcorn provides a good amount of water content for effective popping.

Before one starts cooking popcorn, the pressure inside and outside the kernel is the same. As the temperature inside the kernel climbs above 100° C., the kernel does not generally pop. In fact, at this temperature, only a small amount of water vaporizes because the tough pericarp acts like a pressure vessel preventing expansion and further vaporization. The water within the pericarp becomes superheated. This superheated water and the small amount of high-pressure steam created permeates and penetrates the starch granules and transforms the formerly more solid granules into hot, gelatinized globules and the starch becomes flowable. Then, typically at about 175° C., when the pressure inside the kernel is about 9 atmospheres, the pericarp ruptures and the popcorn pops. In other words, the gelatinized starch granules expand into thin, jellylike bubbles. Neighboring bubbles fuse together and solidify as the temperature drops during expansion, forming a three-dimensional network. The resulting moisture content of the kernel is now about 1-2% by mass, and the popcorn kernel is transformed to what we know as “popped” popcorn.

In the prior art, popcorn has been popped using several methods. The dry method is one such method. For example, early Native Americans have popped popcorn on the cob, or kernels in ceramic pots over open fires. Heated sand was sometimes used. More recently heated salt has been used to pop popcorn. And even more recently, hot-air poppers have been developed, implementing another dry popping method. Typically in a hot-air popper, kernels reside in a hot air stream of a selected velocity in which they are too dense and streamlined to rise to an outlet until heated sufficiently to pop. After popping their density is sufficiently lowered, and their aerodynamic drag is sufficiently raised, that they rise to the outlet. After passing through the outlet they typically fall into a collection container.

Heating by radiation, for example from heating coils or light bulbs, has been used in popping. For example in the latter case, toy ovens using a lightbulb as a heat source have been described as capable of popping popcorn.

Alternatively, “wet” methods using oils have been used. There, the heated oils transfer heat to the water in the starch through the pericarp by contact and conduction. Flavorings can be contained in the oil, through and out of which a popped kernel will rise, supported by adjacent popped kernels. The popcorn will continue to rise out of the oil as new kernels pop and lift the popped kernels above them.

Microwave popping has been a relatively more recent development in the art. This method has been found desirable because a microwave popcorn bag, as is well known can be provided complete with oil and seasoning and is convenient for home popping. When the bag is placed in a microwave oven, the bag expands as the popcorn pops. However, it is not simply only the microwave energy transferred to the water within the pericarp causing internal heating that causes the popcorn to pop. For example, a single popcorn kernel placed in a microwave will typically not pop as well as the same popcorn kernel would inside of a microwave popcorn bag. This is probably because of the heat that is generated within the enclosed microwave popcorn bag by heating the oils, salt, etc. that are often present in microwave popcorn bags. Accordingly in addition to direct heating of the water in the endosperm by microwave energy applied, conducted heat from the oils, etc. which are heated also contribute to effective popping.

Previously known methods and devices for cooking batches of popcorn have inherently presented difficulty with respect to the even popping of popcorn. For example, if a popcorn batch is removed too soon from a cooking apparatus, many kernels will remain un-popped. If, on the other hand, a popcorn batch is left in a cooking apparatus for too long, the popped kernels will burn, creating an unsavory popcorn taste and smell.

A primary cause of this timing problem, whether by wet, dry, or radiation processes, is directly related to the cooking of popcorn in batches. By piling or stacking kernels on top of one another, each kernel often receives a different amount of heat. For example, as each kernel absorbs heat, it can insulate other adjacent kernels and prevent them from receiving the same amount of heat. In other words, the more kernels placed around an individual kernel, the less heat the individual kernel will receive, all other factors being equal. As a result, the kernels receiving the most heat have a tendency to pop first and the insulated kernels have a tendency to pop last. Thus, the less insulated kernels that pop first can be heated for too long a period of time, and are more prone to burning. Conversely, by removing the popcorn batch early to avoid burning, many kernels that are more insulated will not pop at all.

Further, in typical microwave popping the microwave energy used to heat and pop the popcorn kernels contained in a microwave popcorn bag system comes from a conventional microwave oven source. Because microwave ovens operate at a single frequency, and are intended for general purpose use in re-heating and cooking a wide variety of foods, they do not take advantage of economies that might be realized by using an electromagnetic wave frequency (wavelength) that would be more suited for optimal popcorn popping, particularly in the absence of a bag and/or oils.

### SUMMARY OF THE INVENTION

As a result, the inventors have recognized that there is a need for a method and/or apparatus for popping popcorn kernels in a given amount of time without substantial over- or under-cooking individual kernels.

The present invention is drawn toward methods and apparatus for optimizing the popping of popcorn. Particularly, a method in accordance with the invention for popping a kernel of popcorn includes selecting an electromagnetic wave frequency that is substantially optimally matched to heat a water-containing portion of the kernel, and which optimally avoids substantially heating a pericarp of the kernel; and exposing the kernel to sufficient electromagnetic wave energy at said frequency (wavelength) to enable the kernel to pop.

In a further, more detailed, aspect of the invention, a popcorn popping apparatus in accordance with principles of the invention includes a tray configured for holding un-popped popcorn kernels in substantially a single layer; and an electromagnetic wave source configured for emitting electromagnetic wave energy at a frequency which is substantially optimally matched to heat a water-containing portion of the kernel, and which avoids substantially heating a pericarp of the kernel, said source and apparatus being configured to enable relatively positioning the tray and source so that radiant energy is projected substantially uniformly onto the single layer in the tray. In further detail, the tray can be part of a conveyer system provided to enable continuous feeding of kernels for popping.

In a further, more detailed, aspect the apparatus can be configured for serial delivery of kernels for popping to a location adjacent the radiation source. The kernels can be serially disposed one behind another on a conveyor. The conveyor can comprise a tape or continuous belt, which can be configured to have a sticky surface to hold the kernels in place until popping detaches them and propels them away from the sticky surface. In another more detailed aspect the belt or conveyor can further comprise trays or compartments, each holding a substantially uniform amount of kernels. Each can be configured to hold one kernel. The trays or compartments are presented sequentially at a uniform rate to the radiation source to facilitate uniform popping at an optimized rate.

In a further more detailed, aspect the serial presentation of kernels to the radiation source can be by means of a vibrating bed or conveyer. The vibrations can be of a nature and of a frequency calculated to move the kernels into and out of an area of exposure to the radiation from the radiation source. The vibrations can be of a nature so as to spread the kernels out in a single layer of substantially uniform density moving through an area of projected radiation at a uniform rate to enable optimized popping of the kernels.

In a further more detailed aspect, an electromagnetic wavelength (or frequency, as speed is constant) optimal to pop a popcorn kernel can be selected by examining the absorption spectra of the various layers of the popcorn kernel. Particularly the absorption spectra of the pericarp and the translucent endosperm primarily responsible for popping are examined. A wavelength is optimal if it is minimally absorbed by the pericarp but is well absorbed by the translucent endosperm. In a further detailed aspect this can be determined by examining light of various wavelengths which is reflected from, or passed through samples of the pericarp and endosperm in comparison with light of the same wavelengths directly. Comparison shows which wavelengths are well absorbed, which are well reflected, and which minimally interact with the material as it passes through. From this information an optimal wavelength can be selected that will pass through the pericarp without substantially heating it to the point it burns over the time required for the same radiation to heat the water in the pericarp sufficiently to enable popping.

In another more detailed aspect, heating with the optimal wavelength selected can be combined with heating by conventional microwave energy. In this combined approach the microwave energy supplements that of the other wavelength(s) within an optimal range, but is of small enough magnitude that it does not substantially burn the pericarp.

Other features and advantages of the invention will be apparent with reference to the following detailed description of exemplary embodiments and the appended drawings, which illustrate by way of example such features and advantages.

### BRIEF DESCRIPTION OF THE DRAWINGS

FIG. 1 is a schematic elevation view of an embodiment of a popping system in accordance with principles of the present invention;

FIG. 2 is a top schematic view of a conveyer system configured for use with the embodiment of FIG. 1;

FIG. 3 is a top schematic view of a conveyer system in another embodiment configured for use with the embodiment of FIG. 1;

FIG. 4 is a top schematic view of a conveyer system in another embodiment configured for use with the embodiment of FIG. 1;

FIG. 5 is a schematic illustration, partially in section, of an embodiment of a portion of an optimization system in accordance with the invention; and, FIG. 6 is a schematic illustration, partially in section of another embodiment of the system of FIG. 5.

It will be appreciated that the drawings are not to scale. The drawings are exemplary schematic representations, and are not intended to portray specific parameters of any such example of an embodiment the invention. As the drawings are intended to depict only examples of possible embodiments to illustrate principles of the invention, they should not be considered as limiting the scope of the invention.

### DETAILED DESCRIPTION OF PREFERRED EMBODIMENT(S)

For the purposes of promoting an understanding of the principles of the invention, reference will now be made to the exemplary embodiments, and specific language will be used to describe the same. No limitation of the scope of the invention is thereby intended. Alterations and further modifications of the inventive features illustrated herein, and additional applications of the principles of the invention as illustrated herein will be apparent to one skilled in the relevant art having possession of this disclosure, and therefore are to be considered within the scope of the invention.

The singular forms “a,” “an,” and, “the” include plural referents unless the context clearly dictates otherwise. Thus, for example, reference to “a kernel” can include reference to one or more of such kernels.

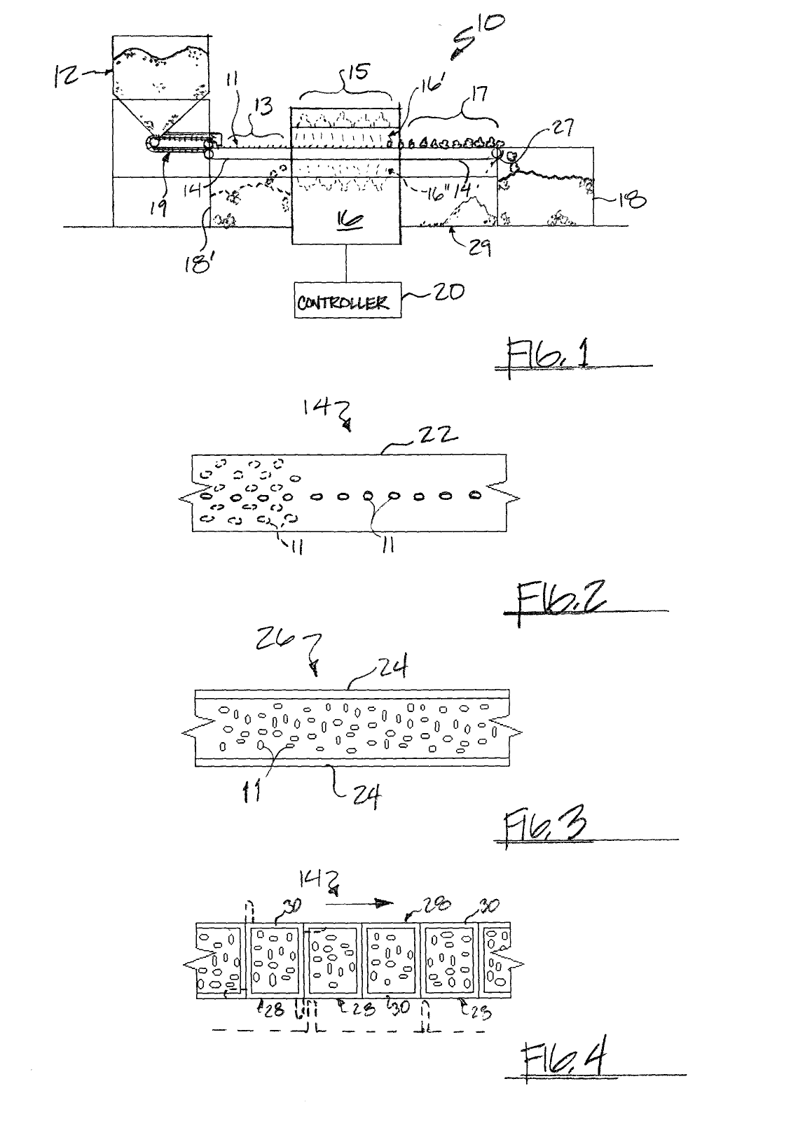

Referring now to FIG. 1, a popcorn-popping device 10 has a kernel storage area 12, a conveyor system 14, a heating device 16, and a container 18. The conveyor system 14 can optionally have three zones: a kernel transport zone 13, a kernel heating zone 15, and a popped popcorn kernel transport zone 17.

In operation, popcorn kernels 11 can be stored in the storage area 12, where a measured, controlled amount of kernels are delivered to the conveyor system 14. In one embodiment, the kernels placed onto the conveyor system can be arranged as a single layer of spaced-apart non-stacked kernels. A dispenser 19 providing for uniform feeding of the kernels facilitates even dispensing of kernels onto the conveyor for this purpose. The dispenser can be coordinated with the conveyor to provide a desired number of kernels per unit time depending on the speed of the conveyor system 14. The conveyor system 14 can then be used to transport the kernels through the kernel transport zone 13 and into the kernel heating zone 15 for popping. The heating device 16 is preferably configured to provide a flood of radiation 16′ at an electromagnetic wave frequency (wavelength) that is substantially optimally matched to heat a water-containing portion of the kernel, and which avoids substantially heating so as to cause burning of a pericarp portion of the kernel. Additionally, depending on the wave frequency and the intensity selected, different time periods can be used for optimal popping. In one embodiment, the frequency, the intensity, and/or the time period can be selected and maintained during production using a controller 20.

Though the heating device 16 is shown above and below the conveyer system 14, this is for simplicity of the schematic representation. One skilled in the art would recognize that the heating device 16 can be placed anywhere in relation to un-popped kernels to effectuate popping. For example, an overhead position may be preferred in certain embodiments. Optionally, the popped kernels can be transported through transport zone 17 and be deposited into container 18. In this embodiment, the transport zones 13,17 are used for convenience and are not required in the present device.

Referring to FIG. 2, a top schematic view of one embodiment of the conveyor system 14 is shown. The conveyer system in this embodiment comprises a continuous or spool-fed tape 22 that may have individual kernels 11 stuck to a sticky surface in a single line as shown. Alternatively, the kernels 11 can be stuck to the surface of the continuous tape 22 in other configurations such as, for example, randomly or in multiple rows. In this embodiment, the kernel sticky tape 22 can continuous, with a sticky substance applied as needed, or can be single-use and be wound up and stored adjacent the storage area 12 or other structure, and pulled through zones 13, 15 and 17, to thereby discard the popped kernels into the container 18. The tape can have sufficient tackiness to hold the kernels 11 but not retain or hold the popped kernels on the surface. Such sticky substances can be for example a viscous oil or shortening, a sugar-based syrup, or another polymeric substance. The materials that can be used are those known to be safe and approved for the use described. Additionally if the tape 22 is not a continuous belt, the tape, once used, can be discarded into a discard bin (not shown) after depositing the popped kernels into container 18. As will be appreciated, in the tacky surface embodiment the popping advantageously can occur below the conveyor 14, where radiation 16″ is applied as shown in broken lines adjacent the alternate heater location and storage bin 18′. The advantage of such a configuration is that the popcorn will pop off the tape and down into the storage bin. In another embodiment the tape can be disposed vertically through the heating zone 15, with the effect of allowing the popped kernels to be propelled by popping outward and downward from the tape to a collection bin.

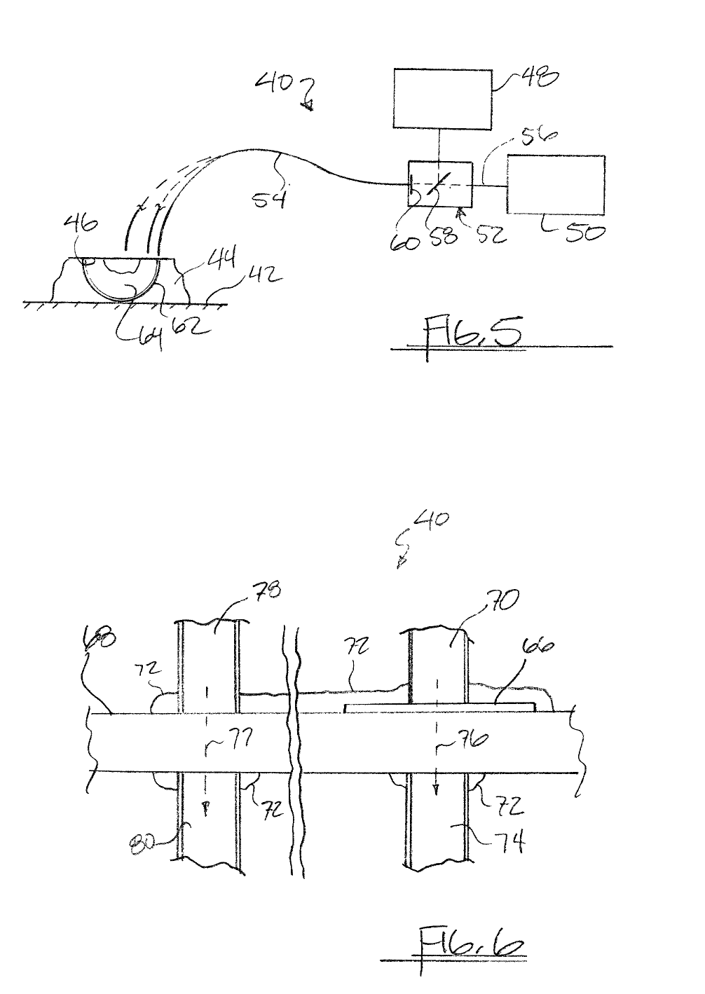

Referring to FIG. 3, a top schematic view of a second embodiment of the conveyor system 14 is shown. There, a reclining and vibrating ramp 26 having walls 24 is present. The kernels 11 can be stored in the storage area 12 and deposited onto the vibrating ramp 26 at a controlled rate. In this embodiment, the ramp 26 can be slanted downward enough to allow the vibration to move the kernels 11 through zones 13, 15 and 17, where popped kernels can be deposited into the container 18. In one embodiment, the storage area 12 can be configured to deposit a steady flow of kernels onto the vibrating ramp so that the kernels 11 are not detrimentally stacked or crowded together. The surface of the ramp 26 can be constructed of a material having a frictional coefficient that allows for appropriate movement speed down the ramp 26. Thus, the slope of the ramp, vibrational frequency and intensity of the vibration of the ramp, the frictional coefficient of the ramp surface, and the wavelength and intensity of the heating device 16 can be configured to work cooperatively to provide a transport speed and radiant energy uptake by the kernels so that substantially all of the kernels pop, leaving a minimum of un-popped kernels.

Referring again to FIG. 1, a guard 27 can be positioned adjacent an end of the conveyor 14 which is close enough to the conveyor that popped popcorn cannot enter the space between the guard and the conveyor, but un-popped kernels can. Un-popped kernels are thus caught before dropping into the storage bin 18 and are routed to an un-popped kernel storage bin 29. In the case of the ramp 26 of FIG. 3, the guard will likewise be placed against an end portion to catch un-popped kernals but not popped kernels which will fall into a storage bin such as shown in FIG. 1.

Referring to FIG. 4, in another embodiment, a series of rectangular holders 28 are present that can be flexibly attached to one another for pushing/pulling each other along in a train-like fashion or are attached to a flexible continuous belt from below. The holders have raised walls 30 for holding batches of un-popped kernels together. In operation, each holder 28 can receive a measured number of kernels from the storage area 12 and move through zones 13, 15 and 17, where popped kernels can be deposited into the container 18. In this embodiment, holders 28 can operate like a conveyor belt 14 described above, where empty holders 28 would be cycled back to the storage area 12 to be refilled with fresh kernels 11. Additionally, the storage area 12 can be configured to deposit a steady flow of kernels onto the holders so as not to detrimentally stack or crowd the individual kernels together. For example a blade (not shown) can be used to level the kernel batch in each tray to provide one layer. In this regard, the walls 30 are of a height calculated to facilitate removing all but a single layer of kernels when a tray moves under the blade.

One of ordinary skill in the art of constructing popcorn machines and cooking popcorn will realize many advantages from using the illustrated embodiment(s). For example, the fact that the kernels can be more spaced apart and less stacked on top of each other solves some of the popping problems mentioned above. Thus, each kernel can pop faster. Additionally, the conveyor can prevent popped kernels from remaining in the heating zone too long, thus reducing and even preventing burning.

With reference to FIG. 5, an example of an apparatus 40 for finding a range of electromagnetic wave frequencies which will facilitate popping of a specific kind of kernel. A kernel 11 of interest is prepared by attachment to a substrate 42 by a suitable cement, epoxy or other adhesive 44. The kernel is then sectioned by grinding to provide a surface 46 for investigation. A spectrometer 48, a light or other radiation source 50, and a beam splitter 52 are connected to a fiberoptic fiber 54. Electromagnetic radiation of various wavelengths from the light source, which can be interchangeable to provide such variety of frequencies passes through a dichoric 58, for example a partially silvered mirror disposed at an angle to the optical axis of the beam of light 56 and enters the fiber optic or is reflected back by a mirror 60 acting as a shutter, for example by rotating about an axis displaced from the beam axis. Light entering the fiber 54 travels to the surface 46 and is absorbed or reflected back through the fiber optic cable into the beam splitter where it is reflected by the dichoric into the spectrometer. Thus spectra from the light source reflected by the shutter and reflected by the surface at the kernel can be compared.

As the fiber 54 is placed adjacent different layers of the kernel, for example the pericarp 62 and endosperm 64, comparative absorption and reflection of the various wavelengths (frequencies) can be defined empirically. Absorption spectra can be investigated for various wavelengths, and wavelengths which result in relatively high absorption by the endosperm and relatively low reflection and absorption by the pericarp will give optimal popping for the kernel investigated. Thus the system can be optimized for different strains, and different batches.

With reference to FIG. 6, in another embodiment, a small thickness section 66 of a particular material, be it the pericarp or endosperm or other portion of the kernel is prepared and mounted on a transparent substrate 68. A fiberoptic element 70 from a light source (50 in FIG. 5) is coupled to the sample by a suitable clear adhesive 72. A second fiber 74 is positioned to receive light 76 passed through the sample and return it to a spectrometer (48 in FIG. 5). Again, spectra of light is compared, that from the source to that which has passed thorough the sample. In one embodiment light 77 from the source is passed through similar fiber optic elements 78, 80 and the substrate 68, and this is what is compared to that passing through the sample to correct for any error introduced in the investigational apparatus. An apparatus employing a beam splitter and shutter to alternate between the first set of fibers 70, 74 and the second 78, 80 for the comparison at the spectrometer.

In this second embodiment of the apparatus 40, samples of different parts of the kernel are investigated, and again electromagnetic wave frequencies which are well absorbed by the endosperm but pass through the pericarp relatively well are found. These frequencies are the ones used in the apparatus 10 described above or another apparatus using a electromagnetic wave energy to heat the water in the endosperm of the kernel for popping.

With the foregoing description and the drawing figures in mind, a method for popping a kernel of popcorn comprises the steps of selecting an electromagnetic wave frequency that is substantially optimally matched to heat a water-containing portion of the kernel, and which avoids substantially heating or burning a pericarp portion of the kernel; and exposing the kernel to the electromagnetic wave frequency at an intensity and for a period of time sufficient to enable the kernel to pop. The water-containing portion of the kernel to which the electromagnetic wave frequency is substantially optimally matched can be the endosperm. Even more specifically, the water-containing portion of the kernel that is focused on can be the tightly packed translucent portion of the endosperm.

An electromagnetic energy wave source that is substantially optimally matched to heat a water-containing portion of the kernel, and which avoids substantially heating a pericarp of the kernel can be selected for use. For example, in one embodiment, the electromagnetic wave frequency can be in the near infrared to the infrared range. In another embodiment, the electromagnetic wave frequency can be in the visible light range. In another embodiment the frequency can be in the microwave range. More specifically, the inventor has discovered that an electromagnetic wave frequency in the range of about 10¹¹ to about 10¹⁶ Hz is suited to heat a water-containing portion of the kernel, and which avoids substantially heating to the point of scorching or burning a pericarp portion of the kernel. This frequency (range) is given by way of example only. Other frequencies can also potentially be used with the present method, depending on the properties of the kernel of interest to be popped. The operative principle is maximizing heating of the water in the translucent endosperm while at the same time minimizing heating of the pericarp. As will know doubt be appreciated, in practice an exemplary sample of a lot of popcorn of substantially uniform type, water content, etc. is tested, and the frequency empirically found to work best can be used to pop the large quantity.

Further, the kernel can also be exposed to a plurality of electromagnetic wave frequencies that are substantially optimally matched to heat a water-containing portion of the kernel, and which avoids substantially heating a pericarp of the kernel. For example, two or more frequencies can be selected that accomplish this goal, and both can be used simultaneously, or pulsed one after the other. Moreover, as it is known that microwave energy of conventional frequency and generated conventionally can be used to supplement the optimized electromagnetic wave energy, the former being limited in power so as not to damage by burning or scorching the pericarp in popping or any part of the popped popcorn, but lowering the power requirement of the optimized electromagnetic wave source.

Though the present method can be used so that a single kernel 11 be popped, it is preferred that a plurality of kernels are exposed simultaneously to the radiant energy source at the selected electromagnetic wave frequency, and are thus popped in close proximity both spatially and in time. For example, the plurality of kernels can be positioned in substantially a single layer of kernels as described in connection with the previous figures. Further, the single layer of kernels can be positioned for popping by a conveyer system, also describe previously. In one embodiment, the conveyer system can be configured to carry substantially spaced apart kernels. If such a conveyer system is used, the system can comprise a storage container for holding un-popped popcorn kernels; a heating zone for exposing the un-popped popcorn kernels to the electromagnetic wave frequency; and a conveyer device for transporting un-popped popcorn kernels from the storage container to the heating zone. Optionally, the conveyer system can further comprise a popped popcorn collecting container configured for collecting popped popcorn from the conveyer device.

Next, in connection with the above figures, a popcorn popping apparatus has been disclosed comprising a tray for holding un-popped popcorn kernels in substantially a single layer; a electromagnetic wave source configured for emitting an electromagnetic radiant energy at an optimal wave frequency onto the single layer, and optimal wave frequency is substantially optimally matched to heat a water-containing portion of the kernel, and which avoids substantially the kernel. Optionally, the apparatus can further comprise a control mechanism for adjusting the electromagnetic wave frequency and/or intensity for obtaining optimal popping of kernels with minimal heating of the pericarp.

With this apparatus, the single layer of popcorn kernels can be organized in a linear manner, e.g., substantially straight, curved, or other linear configuration. Alternatively, the single layer of popcorn kernels can be randomly assembled, or assembled in a plurality of rows.

The tray can be conveyer device configured to bring the un-popped popcorn kernels into proximity of the source of electromagnetic radiation at an optimal wave frequency to effectuate popping. Effective conveyer systems have been described previously in FIGS. 2-4. For example, in one embodiment, the conveyer device can comprise at least one continuous or non-continuous tape having multiple kernels stuck to a surface of the tape. In another embodiment, the conveyor device can comprise a vibrating ramp. In yet another embodiment, the conveyor device can comprise a series of containers configured to hold separate batches of popcorn kernels.

One skilled in the art will realize that each embodiment of the invention provides for uniform heating times for each of the kernels and thus the ability to pop a higher percentage of popcorn kernels, leaving fewer undesirable un-popped kernels present. This can be achieved by providing a more controlled heating environment, with less insulating of kernels, and/or by controllably moving the kernels into the heating zone for an optimum time. Alternatively, the energy emitted from the heating zone can be switched on and off at appropriate times. Whatever mechanism is used, many consumers will discover that the present invention provides for better tasting popcorn. For example, as the popcorn kernels are not exposed to electromagnetic wave frequencies that will substantially heat or burn the pericarp, better tasting popcorn can be popped. Further, by regulating the amount of time that each kernel is in the heating zone, an even lower probability of burning is present, particularly if a range of electromagnetic frequency is selected rather than a single frequency. Additionally, in one embodiment, a plurality of conveyers can be used under a single energy source, i.e., heating device. Alternatively, a plurality of energy sources can be used to provide electromagnetic wave energy to a single conveyer system containing popcorn kernels. In other embodiments, the kernels can even be moved through the heating zone in several different ways. For example, the kernels could be stopped for a short time in the heating zone or even rotated, for example by vibration of the conveyor, or by partial rotation of the conveyor about a lengthwise axis of the continuous belt. If sufficiently separated the trays of FIG. 4 can be rotated about a vertical axis, for example by providing a rotatable mounting on the conveyor and arms extending laterally to be engaged sequentially by stationary prongs and thereby be ratcheted around as the conveyor progresses. The method of operation will depend further upon the size and power of the heating device and the rate movement of the conveyor system.

While the invention has been illustrated with specific reference to these before-describe embodiments, it will be recognized that changes can be made in form and detail without departing from the spirit and the scope of the invention. The described embodiments are to be considered in all respects only as illustrative and not restrictive. The scope of the invention is, therefore, indicated by the appended claims rather than by the foregoing description. All changes that come within the meaning and range of equivalency of the claims are intended to be embraced within their scope.

What is claimed is:

1. A method for popping a kernel of popcorn using electromagnetic waves, comprising:
(a) selecting an electromagnetic wave frequency that is within a range substantially optimally matched to heat a water-containing portion of the kernel, and which avoids substantially burning a pericarp portion of the kernel; and
(b) exposing the kernel to electromagnetic radiation at said electromagnetic wave frequency provided at sufficient intensity for a period of time sufficient to enable the kernel to pop.

2. A method as in claim 1 wherein the water-containing portion of the kernel is an endosperm portion.

3. A method as in claim 2 wherein the water-containing portion of the kernel is a translucent portion of the endosperm.

4. A method as in claim 1 wherein the electromagnetic wave frequency is in the near-infrared through infra-red range.

5. A method as in claim 1 wherein the electromagnetic wave frequency is in the range of about 10¹¹ Hz to about 10¹⁶ Hz.

6. A method as in claim 1 wherein the electromagnetic wave frequency is determined by observing the peak absorption spectra for the endosperm portion primarily involved in popping and for the pericarp and selecting a frequency minimally absorbed by the pericarp which is effective in heating the endosperm portion.

7. A method as in claim 1 wherein the kernel is exposed to a radiation at a plurality of electromagnetic wave frequencies that are substantially optimally matched to heat a water-containing portion of the kernel, and which are selected to avoid substantially burning a pericarp of the kernel.

8. A method as in claim 7 wherein the kernel is also simultaneously exposed to microwave energy at a magnitude below that which will substantially burn the pericarp during the time of exposure to microwave radiation.

9. A method as in claim 1 wherein a plurality of kernels are exposed to the radiation and are positioned in substantially a single layer of kernels.

10. A method as in claim 9 wherein the single layer of kernels are positioned for popping by a conveyer system.

11. A method as in claim 10 wherein the conveyer system is configured to carry substantially spaced-apart kernels.

12. A method as in claim 10 wherein the conveyor system comprises:
a storage container for holding un-popped popcorn kernels;
a heating zone for exposing the un-popped popcorn kernels to radiation at said electromagnetic wave frequency;
a conveyer device for transporting un-popped popcorn kernels from the storage container to the heating zone.

13. A method as in claim 12 wherein the conveyer system further comprises:
a popped popcorn collecting container configured for collecting popped popcorn from the conveyer device.

14. A popcorn popping apparatus, comprising:
(a) a tray for holding un-popped popcorn kernels in substantially a single layer; and
(b) an electromagnetic wave source configured for emitting an electromagnetic wave frequency onto the single layer, and which is substantially optimally matched to heat a water-containing portion of the kernel, and which avoids substantially heating a pericarp of the kernel.

15. A popcorn popping apparatus as in claim 14 further comprising a control mechanism for adjusting the electromagnetic wave frequency for obtaining optimal popping of kernels with minimal heating of the pericarp.

16. A popcorn popping apparatus as in claim 14 wherein the single layer of popcorn kernels is a linear.

17. A popcorn popping apparatus as in claim 16 wherein the linear single layer of popcorn kernels is substantially straight.

18. A popcorn popping apparatus as in claim 14 wherein the tray is a conveyer device configured to bring the un-popped popcorn kernels into proximity of the electromagnetic wave frequency to effectuate popping.

19. A popcorn popping apparatus as in claim 18 wherein the conveyer device comprises at least one continuous tape having multiple kernels stuck to a surface of the tape.

20. A popcorn popping apparatus as in claim 18 wherein the conveyor device comprises a vibrating ramp.

21. A popcorn popping apparatus as in claim 18 wherein the conveyor device comprises a series of containers configured to hold separate batches of popcorn kernels.

22. A popcorn popping apparatus as in claim 1, wherein the frequency of the electromagnetic wave energy is determined by observing absorption spectra for light of various frequencies of the pericarp and the endosperm and selecting a frequency minimally absorbed by the pericarp and well absorbed by the endosperm, respectively.

23. The apparatus of claim 22, wherein the frequency is selected by observing absorption of radiation reflected from pericarp and endosperm material, respectively, of a popcorn kernel.

24. The apparatus of claim 22, wherein the frequency is selected by observing the absorption of radiation passed through a sample of endosperm and pericarp material, respectively.

25. An apparatus for popping a kernel of popcorn, comprising a source of electromagnetic radiation, the kernel and said radiation source being positionable with respect to each other so that the radiation sufficiently heats water in an endosperm portion of the kernel to enable the kernel to pop, said source of electromagnetic radiation being configured to emit radiation having a wavelength selected so that the radiation is minimally absorbed by and does not substantially burn the pericarp in the period of time before the kernel pops, and also is absorbed sufficiently by the endosperm to enable popping before substantial burning of the pericarp.
